(19) United States
(12) Patent Application Publication
(10) Pub. No.: US 2014/0278718 A1
(43) Pub. Date: Sep. 18, 2014

(54) ENHANCED TIME-MANAGEMENT AND RECOMMENDATION SYSTEM

(71) Applicant: INTERNATIONAL BUSINESS MACHINES CORPORATION, Armonk, NY (US)

(72) Inventors: Peter K. Malkin, Yorktown Heights, NY (US); Jacquelyn A. Martino, Cold Spring, NY (US); Clifford A. Pickover, Yorktown Heights, NY (US); Justin D. Weisz, Stamford, CT (US)

(73) Assignee: International Business Machines Corporation, Armonk, NY (US)

(21) Appl. No.: 13/837,871

(22) Filed: Mar. 15, 2013

(51) Int. Cl. G06Q 10/06

(52) U.S. Cl. CPC G06Q 10/06316
USPC 705/7.26

(57) ABSTRACT

A set of to-do items may be obtained. A specified window of time may be received. A subset of the to-do items may be automatically prioritized as candidate tasks to be performed during the specified window of time. A prioritized subset of the to-do items may be presented. Based on one or more criteria, the mode of interaction with a user with respect to the to-do items may be in virtual universe.

### FIELD

The present application relates generally to computers, and computer applications, and more particularly to computer-implemented time management of activities.

### BACKGROUND

Users may store a schedule of their tasks in an electronic calendar system or the like to help them organize and plan their activities throughout a time horizon. A methodology disclosed herein may provide automatic computerized time-management in performing such tasks.

### BRIEF SUMMARY

A method for time management and recommendation, in one aspect, may comprise obtaining a set of to-do items. The method may also comprise receiving a specified window of time, the window of time representing a block of contiguous time duration that a user is currently available. The method may further comprise automatically prioritizing a subset of the to-do items to be performed during the specified window of time. The method may also comprise determining based on a criterion, whether a mode interaction with the user should be in virtual universe mode. The method may further comprise, in response to determining that the mode of interaction should be in virtual universe mode, putting the mode of interaction with the user to the virtual universe mode, and presenting a prioritized subset of the to-do items via a virtual universe.

A system for time management and recommendation, in one aspect, may comprise a user interaction module operable to execute on a processor, and further operable obtain a list of to-do items. The user interaction module may be further operable to receive a specified window of time representing a block of contiguous time within which a user is available to perform a task. An identification module may be operable to identify a subset of to-do items that can be performed during the specified window of time. A prioritization module may be operable to prioritize the subset of to-do items. A switching module may be operable to determine whether to put a mode of interaction with the user into a virtual universe mode, wherein in response to the switching module determining that the user interaction should be put into a virtual universe mode, the user interaction module places its interaction mode into that of virtual universe.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 illustrates a method of task management and recommendation methodology in one embodiment of the present disclosure.

FIG. 2 illustrates a computerized graphical representation showing a virtual universe in one embodiment of the present disclosure.

FIG. 3 illustrates a time management and recommendation system in one embodiment of the present disclosure.

FIG. 4 illustrates a schematic of an example computer or processing system that may implement a time management system in one embodiment of the present disclosure.

### DETAILED DESCRIPTION

A task management of to-do items that, for example, on-the-fly, recommends a set of to-dos (to be performed tasks) in a specified limited window of time is disclosed. In one example, the task management of the present disclosure may determine a prioritized sub-list of an overall to-do list. The priorities of the tasks in the sub-list may be calculated based on the amount of time the user specifies he or she now has free (e.g., “I'm free for the next 45 minutes.”). In another aspect, the task management of the present disclosure may provide a mode-switching element such that, based on one or more criteria, switches the mode of the to-do list manager to a virtual universe, in which the user may understand and manipulate his or her to-do list subset in an intuitive fashion. Various embodiments the task-management of the present disclosure may be provided as a system, a method, and/or as computer program of instructions executable on a computer processor.

The disclosed task management system and/or method may help people prioritize their to-do items by keeping track of how much time is needed to accomplish each item, how much of one's attention is required to adequately perform the task, how much “ramp-up” time (e.g., preparation time needed to be able to begin the work) is needed to begin working on the task, and interruptibility associated with the to-do items, i.e., how interruptible the task is (e.g., whether the task can begin and be stopped before completion). Here, the term ramp-up time refers to an estimated amount of time required to start a task, and it may include various considerations such as the necessity of locating (i.e., finding) and/or opening various files, locating and/or opening software applications, establishing connections to collaborators via email or instant messaging, and cognitive needs for engaging in a task, such as a complicated task. Some applications may be slower for a user to find and access because they are located on a remote cloud server, whereas others may already be open on a user's computing desktop. This differential amount of time may contribute to ramp-up time. Also, for example, a user may wish to engage in the task of editing a technical paper on paper (which may be useful to avoid eye strain when compared to editing on an LCD screen). This task may involve such considerations as opening the file, printing the file and obtaining the file from the printer, reading figures into a graphical editor to make the figures more readable, and the like. Each of these components of the ramp-up time may contribute to the overall ramp-up time. Some of these activities in this example may be fast (e.g., 20 seconds to find the file and open it using a text editor), while other components may be slower (e.g., 5 minutes for printing a 30 page paper on a printer that is located in an office room that is many aisles away in a large building.)

A user can interact with a system of the present disclosure in one embodiment, to specify how much time the user has and how interruptible the task is. In another aspect, this information may be estimated in automatic fashion by a computer processor, e.g., without user intervention. Using the information, for example, a prioritized list of tasks to work on may be obtained during a specified window of time.

Task management system and/or method of the present disclosure may utilize information the user have previously specified. For example, users may have already entered tasks they need to accomplish in a traditional to-do list, along with assessments of how much time and attention they need to spend on each task. Users may interact with the system of the present disclosure in one embodiment, entering information on how much time and attention they currently have to spend on a subset of to-do items. In response, the task management system of the present disclosure may produce a prioritized list of tasks based on the entered available time and attention.

FIG. 1 illustrates a method of time management and recommendation methodology in one embodiment of the present disclosure. At 102, a list of to-do items may be obtained. For example, an automatic computer program or module may access a user's electronic calendar system and the features contained therein, e.g., read the calendar data stored in the electronic calendar system that specifies the user's tasks and associated time frame, e.g., date and time.

At 104, a specified window of time is received. For example, a user may specify a window of time, for instance, in discovering that the user has the next 45 minutes available. A specified window of time may be also obtained automatically from searching a user's electronic calendar, e.g., for a block of free time.

At 106, a subset of the to-do items may be identified. Such candidate to-do items may be identified, for example, based on a criterion. For example, one or more tasks or to-do items that cannot be completed within the specified window of time may be filtered out, and the remaining to-do items may be identified as the subset of the to-do items. As another example, candidacy may be determined by satisfying a criterion that the time to accomplish the task plus and any additional ramp-up time is less than the user's available time (the specified window of time); user attention needed to perform the task matches the user's available attention capability during that specified window of time, e.g., if a user's attention is divided, a task that requires full concentration may not become a candidate, rather a task that only requires partial concentration may become a candidate. As an example, the available attention of the user may be measured explicitly (e.g., by asking the user how much attention the user can provide) or implicitly by inspecting the user's calendar (e.g., by automatically determining whether the user has a meeting scheduled) or by monitoring the user's activity on the computer (e.g., determining if the user is continuously administering keystrokes and mouse movements or if the user's monitored activity patterns of use show many starts and stops). Other criteria may be used. A subset of to-do items identified at 106 may be for a group of people working together on a set of shared to-do items by taking into account each group member's available time and attention.

At 108, the subset of the to-do items that may be worked on during the specified time window, may be prioritized or ranked. For instance, a computer-implemented management component may automatically prioritize the subset of the to-do items based on one or more criteria. The prioritization may be performed based on one or more criteria, for example, additional properties of the task that is a to-item in the subset of the to-do items. Examples of the properties of a task may include but are not limited to: the time to accomplish the task (e.g., rank or prioritize the shortest tasks first); the amount of attention required for the task (e.g., rank or prioritize the tasks that require partial attention first); the ramp-up time of the task (e.g., rank or prioritize the tasks that will be quickest for the user to begin); the type or kind of task (e.g., rank or prioritize programming tasks first, or show work-related tasks first); the importance, priority, or complexity of the task (e.g., show the most important tasks first, show the simplest tasks first); the people involved in or depending on the task (e.g., show tasks involving my manager first). The one or more criteria for prioritizing may be specified by the user in advance as a preference or they may be specified interactively as the user dynamically re-prioritizes the list.

At 110, a determination may be made as to whether to switch a mode of interaction with a task management system to a virtual universe (VU), e.g., three-dimensional (3-D) interactive environment with one or more avatars. Briefly, avatars refer to computer-generated graphically elements that represent users. For instance, a determination may be made, based on a criterion, whether a mode of interaction with the user should be in virtual universe. At 112, in response to determining that the mode of interaction should be in virtual universe, the mode of interaction with the user is established or switched to a virtual universe mode. The prioritized subset of the to-do items then may be presented via the virtual universe. Otherwise, at 114, the prioritized subset of the to-do items may be presented in non-virtual universe mode.

For example, a mode-switching element, based on one or more criteria may switch the mode of a to-do list manager for interacting with a user to a virtual universe in which the user may understand and manipulate his or her to do list. As an example, if the complexity of the to-do lists exceeds a threshold, then the user may be transitioned from a traditional to-do manager (e.g., a text listing managed with an electric calendar) to one that is managed in a virtual universe, in which to-do items are represented by graphical representation and spatial coordinates are used to help a user manage and/or understand his or her pending to-do items. For instance, a high-importance item involving a user's manager may be represented by a bust of the manager placed in a high-importance region of a 3-D room or scene. Additionally, the virtual universe may be used in a natural way to represent context of to-do items, such as a visual separation of work and home to-do items into regions of space (e.g., rooms, buildings, scenes) that represent these contexts. The spatial positioning of a to-do item represented in a virtual universe may indicate to-do importance. Teleportation functionality provided in virtual universe technology may be used to examine one or more of the to-do lists of others who have given permission.

In many virtual universes, such as Second Life, a teleportation feature allows users' avatars to make sudden transitions from one location to another location in the world. Various means are provided for such abrupt location transitions, and they may involve selecting locations on maps of the world, using search features for different destination locations, etc. As an example, user 1 may be located in a living room (a 3D graphical representation) with a to-do list area 1 in his virtual home. For example, a bust of the manager of user 1 holding a representation of an engine part may indicate a to-do item relating to the manager of the user 1, such as the need to inspect an engine part. User 2 may have a similar to-do list area 2 in the home of user 2. In one embodiment of the present disclosure, user 1 may teleport to the to-do list area 2 to examine to-do lists in this second location in a virtual world.

Examples of criterion used to switch a user to a virtual universe mode may include, but are not limited to, complexity (e.g., number and nature of pending to-dos); timing (e.g., many to-dos per unit time); forecasts (e.g., forecast to-dos based on user history and user calendar); possible confusion among one or more to-do items; an estimated level of distraction during a time period; a crowd-sourcing of the importance of to-do items (e.g., a signal is automatically sent to members of a team, who vote on a user's most important to-dos). For example, if one or more attributes of a task meets a complexity threshold, if there are many tasks per unit of time, there is a confusion among one or more tasks, a level of distraction exceeds a threshold value, or a crowd-sourcing is involved, then the mode of interaction with a task management system may switch to a virtual universe mode.

As an example involving forecasts, it may be that certain kind of to-do tasks have required roughly 5-10 minutes of a user's time in the past. Based on a history of use, the system may make a forecast so that similar tasks may be estimated to required 5-10 minutes of a user's time. Similarly, as another example, based on a day of the week and past use, a user may have entered a virtual universe to interact with a to-do representation. In the past, for example, a user may have often entered a virtual universe to accomplish a 5-minute task involving the checking of a 3-D representation of an engine part. Thus, it may be forecast that a transition to a virtual universe would be likely on a future Friday for a similar task. This forecast of time needed (and the job involved) may be used to trigger (or not trigger) a transition to a virtual universe.

In a virtual universe, a represented reward may be provided for accomplishing a task. Examples of a reward for accomplishing to-dos may include, but not limited to, one or more of virtual universe items, scripts, access to restricted functions, avatar designs, etc. In virtual universes, such as Second Life, users often have an inventory of desirable virtual possessions in the virtual world, such as virtual pets (with behaviors controlled by software scripts), clothing, hair styles, landscape objects on their virtual properties, and the like. Thus, as a reward, a user who accomplishes a task may be offered a reward of a virtual pet or other virtual item that may be stored in a user's inventory of possessions in a virtual universe.

The physical or geographical location of a user may be a criterion that is used in determining or identifying the subset of to-do items as candidate tasks to be performed during the specified time window, and/or in prioritizing the subset of to-do items. For example, a to-do list item may involve individuals in different time zones, who may or may not be available for questions and/or collaboration during a time period, and/or who may or may not be available via instant messaging. This information can be used to increase or decrease the probability that a particular to-do item will be selected for the subset of to-do items to be performed during a period of time (the specified time window). The to-do list subset that is recommended (identified and prioritized) for a particular window of time may also change dynamically based on an automated assessment of user location (for example, location determined by global positioning system (GPS), Internet Protocol (IP) address or the like, location as specified on an electronic calendar, etc.). Thus, for example, a user's to-do list subset may change if the user is in building one (which may have certain equipment, people, colleagues, working conditions, network connectivity/quality of service, security in real world, security in virtual world (virtual universe), computer-server load and response time in a virtual universe, etc.) compared with when the user is in building two.

FIG. 2 illustrates an example of a computerized graphical representation showing a virtual universe in one embodiment of the present disclosure. In a virtual universe representation, one or more high-priority items may be shown or presented as stacked in front of a door (circles in front of the door 202), e.g., because they are determined to be critical for certain pressing projects in the next N days. For example, N may be equal to 2 days for a near-term deadline and 10 days for a longer-term deadline. Lower-priority to-do items are represented as small circles 204, for example, resting on a sofa. Different symbols may be used to represent the tasks in the virtual universe. For example, more informative symbols may be used, representing actual to-do items. In addition, one or more avatars graphically representing one or more users may be provided in the virtual universe. The virtual universe may show the avatars picking up the graphical symbols representing one or more to-do items, which graphical symbols may be “opened up” to reveal more details. Representations in the virtual universe may include such examples as: a bust of people with whom to-do items are associated, a small house representing items to-do at home, a car representing to-do items associated with car repairs, etc. Positions of virtual universe items may also be crowd sourced. For example, a management module or a to-do-list manager module may receive input from a group of users that the group would like a user associated with the virtual universe to see an important to-do item, and in response the management module may present that important to-do item placed in front of the door in the virtual universe.

A computerized prioritization methodology of the present disclosure in one embodiment may also evaluate a specification of an importance function associated with a task item and dynamically determine an importance value of the task item as a function of an avatar's location in a virtual universe. For example, as the avatar moves toward a home, a building, a region of a room, etc., such movement toward a location may trigger a specifying of a likely importance value associated with a to-do item. The avatar may be also moved toward certain to-do items to suggest an importance. In one embodiment of the present disclosure, the importance functions are re-evaluated continuously based on the current values of the context attributes, location of an avatar in a 3-D space, dynamic conditions occurring outside of the virtual universe. The priority values of task items are adapted dynamically and may change through time.

For example, context attributes may relate to the context of a task in relation to other tasks planned for the day, relative estimated importance of tasks with respect to other tasks planned in a window of time, and the current location context of the user, such as his location in a virtual word, location in the real world, etc. Dynamic conditions occurring outside the virtual universe may include such considerations as security considerations (e.g., is the user's laptop in a secure location and currently running anti-virus software, which may be slowing the system), distraction considerations (are other windows popping up on the user's screen, or are there other people in a user's real room as measured by motion detectors), etc.

Additionally, the virtual universe may be used in a natural way to represent context of to-do items, such as a visual separation of work and home to-do items into regions of space (e.g., rooms, buildings, scenes) that represent these contexts.

FIG. 3 illustrates a system in one embodiment of the present disclosure. A user interaction module or functionality 304 of a management component 302 may obtain a list of to-do items, e.g., from searching a user calendar system, from another data document that stores a user's schedule of tasks, or from another source. The user interaction module or functionality 304 of the management component 302 may also receive a user specified window of time representing a block of contiguous time within which a user is available to perform a task. An identification module or functionality 306 of the management component 302 may identify a subset of to-do items that can be performed during the specified window of time, e.g., based on one or more criteria described above. A prioritization module or functionality 308 of the management component 302 may prioritize the subset of to-do items, e.g., based on one or more criteria described above. A switching module or functionality 310 of the management component 302 may determine whether a mode of interaction with a user should be put into or switched to a virtual universe mode, e.g., based on one or more criteria described above. In response to the switching module 310 determining that the user interaction should be in a virtual universe, the user interaction module 304 puts its interaction mode (or switches its interaction mode) to that of virtual universe. The user interaction module presents a virtual universe containing the prioritized subset of to-do items, for example, in various locations based on the priority and represented as graphical symbols therein. Further interactions with a user are performed via the virtual universe. One or more computer processors may implements the one or more of the functionalities shown in FIG. 3.

FIG. 4 illustrates a schematic of an example computer or processing system that may implement a system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 4 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a management module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method for time management and recommendation, comprising:
obtaining a set of to-do items;
receiving a specified window of time, the window of time representing a block of contiguous time duration that a user is currently available;
automatically prioritizing a subset of the to-do items to be performed during the specified window of time; and
presenting a prioritized subset of the to-do items to the user.

2. The method of claim 1, further comprising:
determining based on a criterion, whether a mode of interaction with the user should be in virtual universe mode; and
in response to determining that the mode of interaction should be in virtual universe mode, putting the mode of interaction to the virtual universe mode, and presenting the prioritized subset of the to-do items via a virtual universe.

3. The method of claim 2, wherein the criterion comprises one or more of complexity associated with one or more of the to-do items, timing associated with one or more of the to-do items, forecast associated with one or more of the to-do items, confusion among one or more of the to-do items, or a crowd-sourcing of importance of one or more of the to-do items, or combinations thereof.

4. The method of claim 2, wherein a spatial positioning of a to-do item represented in the virtual universe indicates to-do importance.

5. The method of claim 2, wherein teleportation in the virtual universe is used to examine one or more to-do lists of others who have given permission.

6. The method of claim 2, wherein one or more items of the subset of the to-do item is placed in the virtual universe based on crowd sourcing.

7. The method of claim 2, wherein the virtual universe comprises a graphical symbol representing a user, and an importance value of one or more to-do items in the subset of the to-do items changes as a function of the graphical symbol's location in the virtual universe.

8. The method of claim 2, wherein the virtual universe comprises a graphical symbol representing a user, and a graphical symbol representing a user moves toward a to-do item in the subset of the to-do items to suggest an importance associated with the to-do item.

9. The method of claim 2, wherein importance functions associated with the to-do items are reevaluated continuously based on current values associated with location of a graphical symbol representing a user in the virtual universe and dynamic conditions occurring outside of the virtual universe.

10. The method of claim 2, wherein a reward is provided in the virtual universe for accomplishing one or more of the subset of the to-do items, wherein the reward comprises one or more of virtual universe item, script, access to a restricted function, or one or more designs associated with a graphical symbol that represents a user in the virtual universe, or combinations thereof.

11. The method of claim 1, wherein the prioritizing generates a prioritized list of the to-do items for a group of users working together on one or more items.

12. The method of claim 1, wherein the subset of the to-do items changes dynamically based on an automated assessment of user location.

13.-24. (canceled)
